(19) United States
(12) Patent Application Publication
(10) Pub. No.: US 2019/0369909 A1
(43) Pub. Date: Dec. 5, 2019

(54) HOMOGENEOUS IN-STORAGE COMPUTATION SYSTEM

(71) Applicant: Alibaba Group Holding Limited, Grand Cayman (KY)

(72) Inventor: Shu LI, Santa Clara, CA (US)

(21) Appl. No.: 15/991,403

(22) Filed: May 29, 2018

(51) Int. Cl. G06F 3/06; G06F 12/10; G06F 13/42

(52) U.S. Cl. CPC G06F 3/0659; G06F 3/0613; G06F 2213/0026; G06F 3/0689; G06F 13/4221; G06F 12/10

(57) ABSTRACT

Disclosed are systems, methods, and apparatuses for performing in-storage computation. In one embodiment, a method is disclosed comprising receiving a command, the command including a physical block address (PBA); retrieving data located at the PBA; processing, using a processor and memory of a storage device, the data to generate processed data; and returning, by the storage device to a host device, the processed data.

This application includes material that is subject to copyright protection. The copyright owner has no objection to the facsimile reproduction by anyone of the patent disclosure, as it appears in the Patent and Trademark Office files or records, but otherwise reserves all copyright rights whatsoever.

### BACKGROUND

The disclosed embodiments relate to storage devices and, specifically, to systems, devices, and methods for providing in-storage computation.

Current architectures rely upon solid-state device (SSD) storage modules connected directly to Peripheral Component Interconnect Express (PCIe) ports of central processing units (CPUs). Such interconnects allow for high-speed data transfers from non-volatile storage devices to memory for processing at the CPU.

Despite the improvement in speed by using PCIe, the latency of the PCIe protocol is orders of magnitude greater than the latency between memory and the CPU. Thus, in scenarios where an application manipulates data stored on SSDs, the delay in transferring data from the SSD to memory reduces the overall CPU throughput of the operation. Additionally, the processing performed by the CPU reduces the amount of compute resources available for other tasks.

Current systems attempt to remedy this deficiency by adding additional co-processor devices (e.g., field-programmable gate arrays, graphics processing units, etc.) to process data stored on SSDs. While these systems reduce the processing load of the CPU, they still suffer from the bottleneck formed by PCIe packet processing.

### BRIEF SUMMARY

The disclosed embodiments solve these and other problems by performing in-storage computations at an SSD device before transmitting the return data to the CPU.

In one embodiment, a method is disclosed comprising receiving a command, the command including a physical block address (PBA); retrieving data located at the PBA; processing, using a processor and memory of a storage device, the data to generate processed data; and returning, by the storage device to a host device, the processed data.

In another embodiment, a method is disclosed comprising receiving, by a processor of a host device, a command, the command including a logical block address (LBA); mapping, by the processor, the LBA to a physical block address (PBA) using a system memory; issuing, by the processor, a second command to a storage device, the second command including the physical block address, the second command causing the storage device to retrieve data at the PBA and execute at least one operation using a processing device and memory of the storage device.

In another embodiment, a storage device is disclosed comprising an interface; an array of storage media; a processor; and a memory for tangibly storing thereon program logic for execution by the processor, the stored program logic comprising: logic, executed by the processor, for receiving a command via the interface, the command including a physical block address, logic, executed by the processor, for retrieving data located at the physical block address, the physical block address representing a location of the data in the array of storage media, processing the data to generate processed data, the processing performed using the processor and the memory, and returning, via the interface, the processed data to a host device.

As described above, the proposed embodiments shift processing of the data stored by a storage device into the storage device itself by repurposing the processor(s) and memories employed by storage devices for media management functionality. The resulting architecture reduces the processing load of the host CPU while reducing the negative effects of bus-level packet processing on such requests.

### BRIEF DESCRIPTION OF THE DRAWINGS

The preceding and other objects, features, and advantages of the disclosure will be apparent from the following description of embodiments as illustrated in the accompanying drawings, in which reference characters refer to the same parts throughout the various views. The drawings are not necessarily to scale, emphasis instead being placed upon illustrating principles of the disclosure.

FIG. 1 is a block diagram of a storage system according to some embodiments of the disclosure.

FIG. 2 is a logical diagram of an in-storage computation system according to some embodiments of the disclosure.

FIG. 3 is a block diagram illustrating the architecture of a storage system according to some embodiments of the disclosure.

FIG. 4 is a block diagram illustrating the architecture of an SSD according to some embodiments of the disclosure.

FIG. 5 is a block diagram illustrating a protocol stack for providing in-storage computation according to some embodiments of the disclosure.

FIG. 6A is a packet diagram illustrating a PCIe packet according to one embodiment.

FIG. 6B is a packet diagram illustrating an improved PCIe packet according to one embodiment.

FIG. 7A is a flow diagram illustrating a method for performing global FTL mapping according to some embodiments of the disclosure.

FIG. 7B is a flow diagram illustrating a method for performing in-storage computations according to some embodiments of the disclosure.

FIG. 8 is a hardware diagram illustrating a device for accessing an SSD according to some embodiments of the disclosure.

### DETAILED DESCRIPTION

The present disclosure will now be described more fully hereinafter with reference to the accompanying drawings, which form a part hereof, and which show, by way of illustration, certain example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for the existence of additional factors not necessarily expressly described, again, depending at least in part on context.

The present disclosure is described below with reference to block diagrams and operational illustrations of methods and devices. It is understood that each block of the block diagrams or operational illustrations, and combinations of blocks in the block diagrams or operational illustrations, can be implemented by means of analog or digital hardware and computer program instructions. These computer program instructions can be provided to a processor of a general-purpose computer to alter its function as detailed herein, a special purpose computer, ASIC, or other programmable data processing apparatus, such that the instructions, which execute via the processor of the computer or other programmable data processing apparatus, implement the functions/acts specified in the block diagrams or operational block or blocks. In some alternate implementations, the functions/acts noted in the blocks can occur out of the order noted in the operational illustrations. For example, two blocks shown in succession can in fact be executed substantially concurrently or the blocks can sometimes be executed in the reverse order, depending upon the functionality/acts involved.

These computer program instructions can be provided to a processor of: a general purpose computer to alter its function to a special purpose; a special purpose computer; ASIC; or other programmable digital data processing apparatus, such that the instructions, which execute via the processor of the computer or other programmable data processing apparatus, implement the functions/acts specified in the block diagrams or operational block or blocks, thereby transforming their functionality in accordance with embodiments herein.

For the purposes of this disclosure a computer-readable medium (or computer-readable storage medium/media) stores computer data, which data can include computer program code (or computer-executable instructions) that is executable by a computer, in machine-readable form. By way of example, and not limitation, a computer-readable medium may comprise computer-readable storage media, for tangible or fixed storage of data, or communication media for transient interpretation of code-containing signals. Computer-readable storage media, as used herein, refers to physical or tangible storage (as opposed to signals) and includes without limitation volatile and non-volatile, removable and non-removable media implemented in any method or technology for the tangible storage of information such as computer-readable instructions, data structures, program modules or other data. Computer-readable storage media includes, but is not limited to, RAM, ROM, EPROM, EEPROM, flash memory or other solid-state memory technology, CD-ROM, DVD, or other optical storage, magnetic cassettes, magnetic tape, magnetic disk storage or other magnetic storage devices, or any other physical or material medium which can be used to tangibly store the desired information or data or instructions and which can be accessed by a computer or processor.

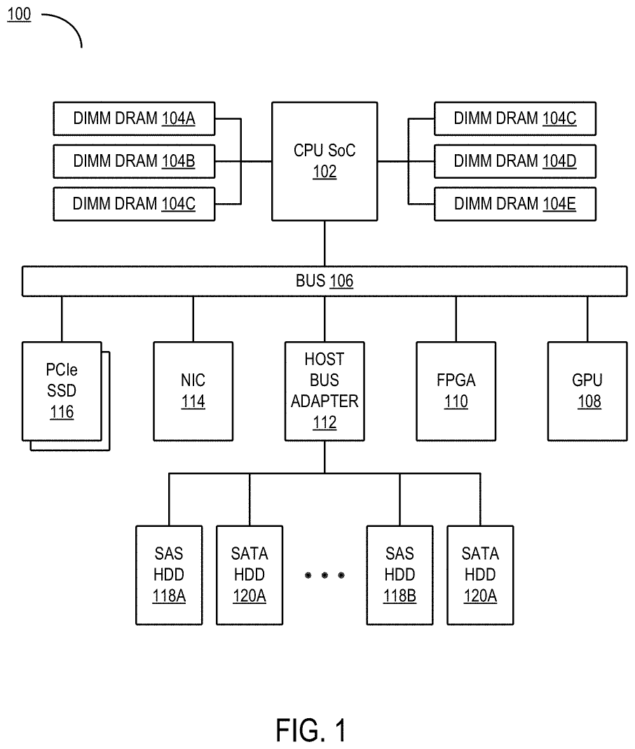

FIG. 1 is a block diagram of a storage system according to some embodiments of the disclosure.

In the illustrated embodiment, the system (100) includes a central processing unit (CPU) System-on-a-chip (SoC) (102) and a plurality of dual in-line memory module (DIMM) dynamic random-access memory (DRAM) (104A-104E). DRAMs (104A-104E) provide volatile storage for operations performed by CPU (102). CPU (102) may comprise a System-on-a-chip (SoC), general purpose processor, or other processing device. In the illustrated embodiment, DRAMs (104A-104E) store, for example, applications or other software executed by the CPU (102) as well as data used by such applications.

CPU (102) communicates with external devices via bus (106). In one embodiment, the bus (106) is a PCIe bus. Bus (106) allows CPU (102) to communicate with various devices which may be on the same board as the CPU (102) or on external boards. For example, GPU (108), FPGA (110), host bus adapter (HBA) (112), network interface card (114), and PCIe solid state devices (SSDs) (116) are connected to bus (106). Further, a plurality of serial attached small computer system interface (SAS) drives (118A, 118B) and serial AT Attachment (SATA) drives (118C, 118D) are communicatively coupled to the CPU (102) via the HBA (112).

In systems such as that illustrated in FIG. 1, CPU (102) frequently accesses data stored on drives (116, 118A-118E). For example, during startup CPU (102) must access the drives (116, 118A-118E) to load the operating system. CPU (102) additionally reads and writes data to drives (116, 118A-118E) in response to system calls issued by applications (i.e., opening and saving files for permanent storage). In general, when accessing PCI SSD (116), a system call issues a request for accessing a file managed by a filesystem. The operating system converts this file to a logical block address (LBA) associated with the PCI SSD (116). The CPU (102), or DRAMS (104A-104E), transmit the command with the LBA to the PCI SSD (116). The PCI SSD (116) includes a processor and DRAM module (not illustrated in FIG. 1, but illustrated in later Figures). The processor receives the request and maps the LBA to a physical block address (PBA). This LBA-PBA mapping is stored within the DRAM. Thus, the PCI SSD (116) processor retrieves the PBA from the PCI SSD (116) DRAM using the mapping. In current systems, this LBA-PBA mapping utilizes all, or nearly all, of the DRAM capacity given the size of the underlying Flash storage medium. After retrieving the PBA, the processor of the PCI SSD (116) accesses the underlying Flash medium via a standard Flash interface and returns the data to the CPU (102) or DRAMS (104A-104E) via bus (106). The above description omits certain details of standard SSD operations (e.g., error correction, bad block identification, wear leveling) for the sake of clarity.

In earlier systems, the CPU (102) would be responsible for processing data returned from PCIe SSD (116). For example, in some instances, the PCIe SSD (116) would return an array of data which the CPU (102) sorts by a predefined key. In these earlier systems, the CPU (102) would sort the data in memory, utilizing processor bandwidth in the process of sorting. In other designs, co-processors such as FPGA (110) and GPU (108) were added to the system (100) (or repurposed) to perform processing on SSD data.

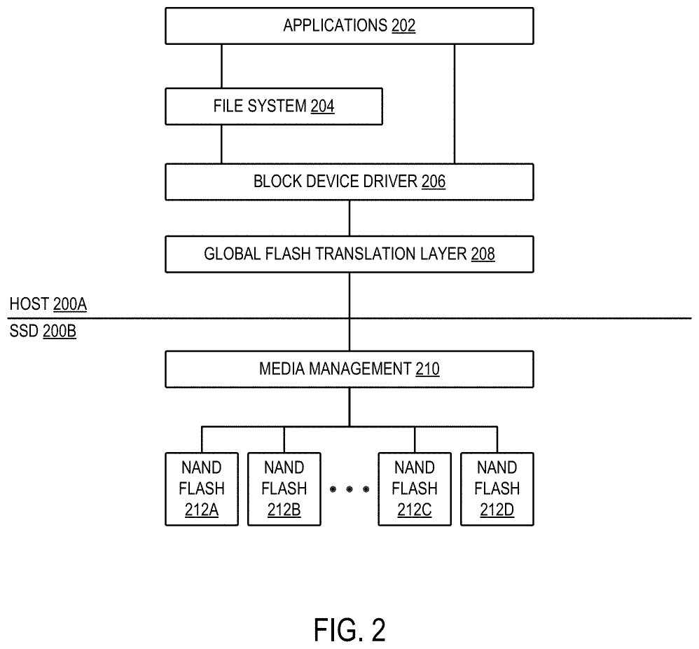

FIG. 2 is a logical diagram of an in-storage computation system according to some embodiments of the disclosure.

The illustrated embodiment depicts the various layers of a host (200A) and an SSD (200B). As illustrated, a host (200A) includes one or more applications (202) such as operating systems, user applications, and any other application requiring storage of and access to data. In some embodiments, applications (202) access the underlying storage medium via system calls to the file system (204). Alternatively, or in conjunction with the foregoing, the applications (202) may access data directly using a block-based device driver (206). In the illustrated embodiment, the block device driver (206) provides a standard block-based interface for accessing the underlying storage media which, as depicted, may comprise NAND Flash (212A-212D) although other media may be utilized in lieu of NAND Flash. In the illustrated embodiment, block device driver (206) converts the file access commands to LBA-based commands.

In the illustrated embodiment, a new layer, the global Flash translation layer (208) is added to the host device (200A). In one embodiment, the layer (208) comprises a driver or kernel extension configured to convert LBAs generated by the block device driver (206) to PBAs readable by the SSD (200B). In one embodiment, the global Flash translation layer (208) receives an LBA from the block device driver (206) and converts the LBA to a PBA using an LBA-PBA mapping stored in the system memory of the host (200A).

As will be described, an LBA-PBA mapping may be stored in system memory (e.g., RAM). In one embodiment, host (200A) may be connected to SSD (200B) (or multiple SSDs) via a Peripheral Component Interface (PCI) express (PCIe) bus. In one embodiment, the SSDs are connected directly to the CPU of the host (200A) via one or more PCIe lanes (e.g., one, four, eight, or sixteen lanes). The specific details of the PCIe interconnect between the CPU and the SSDs may vary depending on the CPU and SSD used and is not intended to be limited in the disclosure. Indeed, other busses may be used other than PCIe. The embodiments disclosed herein generally describe a directly connected storage device (e.g., via PCIe) versus slower storage devices connected via intermediate chipsets (e.g., south bridges, etc.). Additionally, the embodiments may equally be applied to non-NAND Flash storage provided such storages utilize some type of mapping between logical (or equivalent) addresses and physical (or equivalent) addresses.

In the context of an SSD, each drive is equipped with a DRAM. This DRAM is generally sized proportionally to the capacity of the NAND Flash array. For example, an eight TB NAND Flash array requires an approximately eight GB DRAM. In general, the larger the Flash storage, the large the DRAM required. In conventional SSDs, this DRAM is sized to store the LBA-PBA mapping, and nearly the entirety of the DRAM is utilized to store the mapping. The LBA-PBA mapping is usually written to persistent Flash storage and transfer to DRAM upon startup. In addition to the DRAM, the SSD is equipped with a CPU designed to perform management operations on the Flash array. These operations include LBA-PBA translation (using the DRAM) as well as other management functions such as wear leveling, garbage collection, bad block detection, and other functions.

In the illustrated embodiment, the SSD (200B) may retrieve the LBA-PBA mapping from one or more of the NAND Flash arrays (212A-212D) and store the mapping in DRAM temporarily. The SSD (200B) may then transmit the LBA-PBA mapping to the host (200A) via PCIe. The global Flash translation layer (208) would then receive the LBA-PBA mapping and store the mapping in system memory. In some embodiments, the layer (208) may additionally pre-process the mapping. For example, if the host (200A) is connected to multiple SSDs, each SSD may include the same LBA or PBAs (e.g., LBA0 maps to PBA5, in a simplified addressing example). In other words, SSD0, LBA0 maps to PBA5 and SSD1, LBA0 maps to PBA5. In this example, the layer (208) cannot simply store an LBA0 to LBA5 mapping and instead my preface the LBA identifier with an SSD or device identifier to distinguish between the devices. In other embodiments, the LBA includes SSD device identifying information within the LBA and pre-processing is unnecessary.

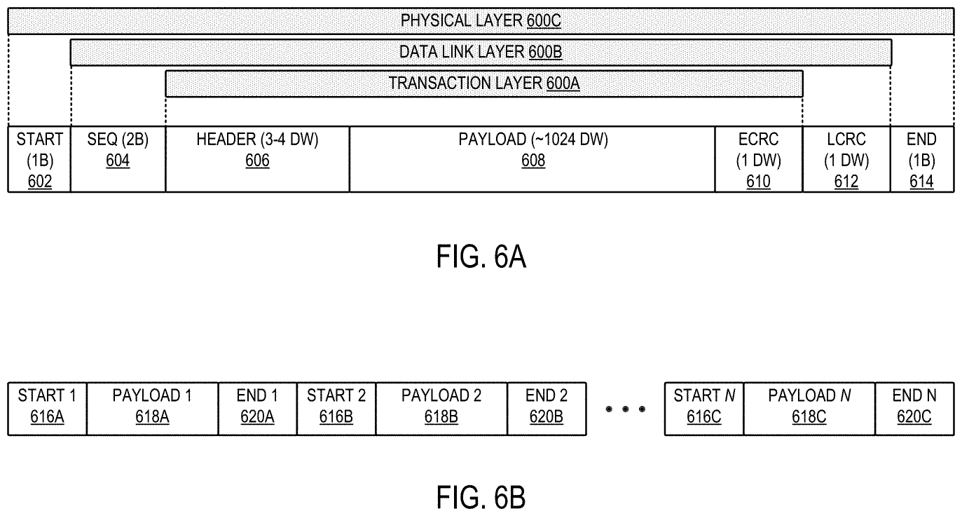

The global Flash translation layer (208) converts LBAs included as part of the block device driver (206) processing to PBAs that may querying system memory. Since the system memory is connected to the CPU over a high-speed memory bus, this translation can be performed significantly quicker than the communications over the PCIe bus (or other, slower busses). Thus, the primary role of layer (208) is to query memory and replace LBAs with PBAs. Layer (208) would additionally process the requests (after replacing the LBA) into a packetized form (discussed more fully in connection with FIGS. 6A and 6B.

Layer (208) then transmits the packetized request over a bus (e.g., PCIe) bus to the SSD (200B). Media management layer (210) then translates the packetized requests into commands to access the NAND Flash devices (212A-212D). The functions of the media management layer (210) are described in more detail herein and are not repeated herein for the sake of clarity.

Media management layer (210) additionally may perform additional functionality not present in convention SSD devices. For example, DRAM of the SSD (200B) may be erased after the LBA-PBA mapping is transmitted to the host (200A). Thus, the DRAM of the SSD (200B) is available for usage by the CPU(s) of the SSD (200B). In some embodiments, the DRAM may be written to with one or more routines or applications for processing data retrieved from the Flash arrays (212A-212D). For example, a sorting program may be stored in memory (originally retrieved from the NAND Flash array). In some embodiments, the packetized command may include a flag indicating a program to run (e.g., the sort program). While processing the packetized request and retrieving the data from the NAND Flash arrays (212A-212D), the CPU(s) may detect this flag, load the retrieved data into DRAM, execute the sort routine stored in DRAM, and return the sorted data back to the host (200A). Thus, the CPU(s) and DRAM of the SSD are fully useable as a computing device rather than being used primarily as support devices for access the NAND Flash arrays (212A-212D).

In one embodiment, the NAND Flash arrays (212A-212D) may include a designated portion for program storage. In this embodiment, an application or driver of the host (200A) may write one or more routines to the NAND Flash arrays (212A-212D). During initialization, the SSD (200B) may read these routines from persistent storage and load the programs into DRAM. Thus, the processing performed by the CPU(s) of the SSD (200B) may be customized to perform any functionality achievable using a general-purpose processor and DRAM.

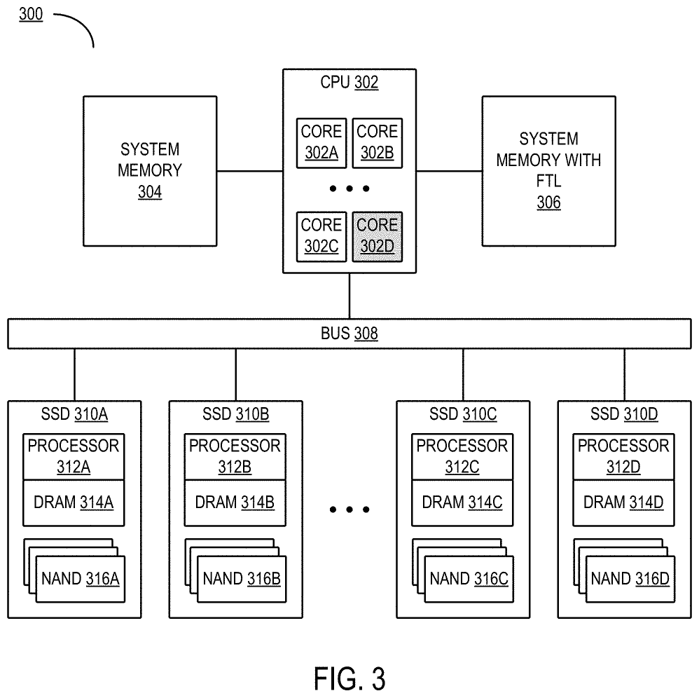

FIG. 3 is a block diagram illustrating the architecture of a storage system according to some embodiments of the disclosure.

In the illustrated embodiment, the system (300) includes one or more CPUs (302). Each CPU (302) includes one or more processing cores (302A-302D). CPU (302) is connected to one or more memory devices (304, 306). In one embodiment, one memory bank (e.g., DIMM) (304) may comprise a standard DRAM memory storage device connected to the CPU (302). Another memory bank (306) may be configured to allocate a dedicated portion of the memory addressing space to the LBA-PBA mapping (i.e., the Flash translation layer (FTL)). Although illustrated as separate memories, memories (304, 306) may be combined as a single physical or single logical memory.

In one embodiment, one of the processing cores (302A-302D) may be reserved for FTL processing. For example, processing core (302D) may be reserved by the CPU (302) for handling LBA-PBA mapping. In other embodiments, the mapping of LBAs to PBAs may be performed out-of-order by any processing core (302A-302D). In this embodiment, the mapping instructions may be interleaved or threaded with other application software. However, when a dedicated processing core (302D) is used for FTL processing, the overall speed of the mapping is increased as the core (302D) does not need to compete with other cores (302A-302C) for resources.

CPU (302) is connected to SSDs (310A-310D) via a bus (308). As discussed previously, bus (308) may comprise a PCIe bus and SSDs (310A-310D) may be connected directly to the CPUs PCIe (or equivalent) ports using the PCIe bus, thus providing rapid access to the SSDs (310A-310D). As illustrated, processing cores (302A-302D) mediate the transfer of data stored in the SSDs (310A-310D) to system memory (304). In other embodiments, SSDs (310A-310D) may be configured to directly access system memory (304) and load data into system memory (304) (e.g., via direct memory access (DMA)).

Each SSD (e.g., 310A) is equipped with a processor (e.g., 312A), DRAM (e.g., 314A), and a NAND Flash array (e.g., 316A). The specific structure of these components is described in more detail in connection with FIG. 2 and the description of these components is incorporated herein by reference in its entirety. As illustrated, CPU (302) can be connected to multiple SSDs (310A-310D) and each SSD (310A-310D) may be similarly or identically structured.

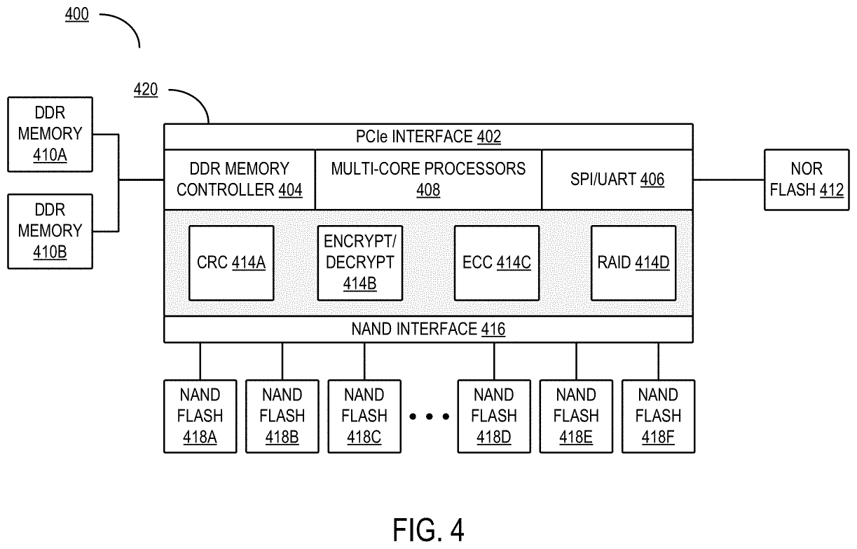

As discussed above, the DRAM of the SSDs is not utilized to store the LBA-PBA mapping as in conventional SSD devices. Thus, the processors and memories in the SSDs are free to perform other operations (in addition to non-mapping SSD management operations). The specific structure of each SSD is described more fully in connection with FIG. 4, which is incorporated herein by reference in its entirety.

FIG. 4 is a block diagram illustrating the architecture of an SSD according to some embodiments of the disclosure.

The illustrated SSD (400) includes a NAND Flash array (418A-418F), NOR Flash device (412), DDR memories (410A, 410B), and a controller (420). NAND Flash array (418A-418F) stores persistent data used by the SSD (400) and has been described previously. DDR memories (410A, 410B) comprise volatile DRAM storage devices used for storing programs and data for use with or generated by such programs. The details of DDR memories (410A, 410B) and NAND Flash array (418A-418F) have been described above and that description is incorporated by reference in its entirety. NOR Flash (412) may comprise a small NOR-based memory for storing firmware instructions. These instructions may comprise the firmware utilized for lower level media management functions performed by the controller (420). These instructions may be flashed to the controller (420) via SPI/UART input (406). In one embodiment, the flashing of the controller (420) with the NOR Flash (412) may include flashing one or more executable programs into DDR memories (410A, 410B). For example, one or more application may be written to NOR Flash (412) by accessing the NOR Flash (412) via PCIe interface (402). When the controller (420) is flashed, these programs are read out from the NOR Flash (412) and written to DDR memories (410A, 410B).

In one embodiment, the controller (420) may be implemented as a system-on-a-chip (SoC). In other embodiments, the components of the controller may be physically separated and connected via traces on a baseboard. For example, DDR memory controller (404) may be physically separate from the other components of the controller (420).

PCIe interface (402) comprises a standard PCIe interface. For example, PCIe Version 3.0 or other versions may be utilized. In some embodiments, while a standard PCIe interface is used, packets transmitted to the processors (408) may comprise custom packets (described in FIGS. 6A, 6B). PCIe interface (402) may be connected to the PCIe pins or lands of processors (408). For example, processors (408) may include a predetermined number of lands/pins for receiving PCIe instructions.

When the processors (408) receive a command over PCIe, the processors (408) execute the command according to the firmware flash from NOR Flash (412). In general, these instructions may be categorized into specific types of commands. One type of commands is administrative commands. Such commands may comprise a command to retrieve an LBA-PBA mapping from the SSD and to return the LBA-PBA mapping back to the host device (for storage in system memory as discussed above). Another type of administrative command may comprise a program storage command, whereby executable code is written to NOR Flash (412) or a designated portion of the NAND Flash array (418A-418F).

A second type of instruction comprises data access instructions. These may comprise read/write/erase instructions operating on data stored in the NAND Flash array (418A-418F). In contrast to conventional SSDs, these commands include at least on PBA of the underlying NAND Flash array (418A-418F). Additionally, the commands may include either a flag identifying a program to run on the SSD or the program itself. For example, DDR memories (410A, 410B) may include a table of programs stored in the form of a pointer array. That is, as an example, the first 32 addresses of memory store pointers to program locations elsewhere in memory. In this embodiment, the read/write/erase command may include a flag comprising a memory address in those 32 addresses to execute upon retrieving the data from NAND Flash array (418A-418F). In an alternative embodiment, the data access command may include the assembly code or machine code in the packetized request to execute itself. That is, the command accesses the NAND Flash array (418A-418F) may store the executable instructions which are loaded by the processors (408) after retrieving the data. In some embodiments, the programs may be cascaded.

For example, a first packet may identify a range of PBAs to retrieve from NAND Flash array (418A-418F). A second packet may specify a sort program at address 0x0001. A third packet may specify a filter program at address 0x0002 as well as one or more filtering options (e.g., based on size). A fourth packet may specify a maximum program which identifies the top item in a sorted list. A fifth packet may comprise a terminating command. In this example, the processor receives the first packet and begins retrieving the requested data at the PBAs from the NAND Flash array. The processor may then receive the second through fifth packets and load the requested programs in memory. Once the data is returned from the NAND Flash array, the processor may then transfer the returned data into memory and execute the sort program on the memory locations, followed by the filter program, followed by the maximum program. Finally, the processor would then return a single value (the maximum value in a sorted/filtered list) to the host device.

FIG. 4 additionally illustrates media management components situated between the processor and the NAND interface (416). In the illustrated embodiment, these components comprise cyclical redundancy checking (CRC) (414A), encryption/decryption (414B), error code correction (ECC) (414C), and redundant array of independent disk (RAID) (414D) functionality. In general, these components may be embedded within the controller and perform lower-level Flash management functionality known in the art. The specific details of these components are not described in detail and may comprise any commonly used implementation of the functionality currently used in the art.

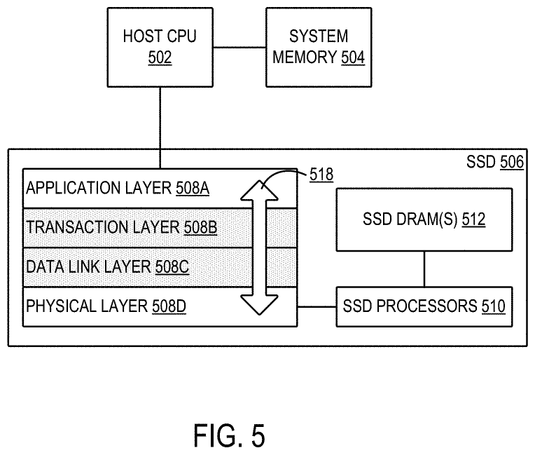

FIG. 5 is a block diagram illustrating a protocol stack for providing in-storage computation according to some embodiments of the disclosure.

In the illustrated embodiment, a host device includes a host CPU (502) and system memory (504). CPU (502) and memory (504) are described more fully in previous figures and the disclosure of the components is incorporated herein by reference in its entirety.

CPU (502) is connected to SSD (506) and another PCIe device (514) via a PCIe bus. In the illustrated embodiment, the SSD (506) processing incoming packets using layers (508A-508D). In one embodiment, each layer (508A-508D) corresponds to a processing performed by a PCIe interface (as described previously). In one embodiment, each layer (508A-508D) corresponds to a PCIe layer according to the PCIe standard.

In one embodiment, packets are first processed by application layer (508A), followed by transaction layer (508B), data link layer (508C), and finally physical layer (508D), and vice-a-versa, depending on whether the interface is transmitting or receiving packets. The application layer (508A) packages data according to the specific requirements of the applications communicating using PCIe and thus varies widely among applications.

FIG. 6A is a packet diagram illustrating a PCIe packet according to one embodiment.

As illustrated, payload (608) comprises data to be transmitted over the PCIe bus. In one embodiment, this payload (608) comprises the application layer data. As illustrated, this data may comprise a 1024 double word (DW) payload. In general, this payload may comprise any binary data.

The transaction layer (600A) is responsible for storing configuration information, managing link flow control, enforcing quality of service (QoS), high-level error checking, and other functions. As illustrated, the payload (608) is wrapped by the transaction layer (600A) to include a header (606) and an end-to-end CRC (ECRC) code (610). The header (606) comprises 3-4 DWs while the ERCR (610) comprises 1 DW. These DWs are added onto the payload (608), increasing the size of the packet. Additionally, the header (606) and ECRC (610) trigger additional processing when processed by SSD processors (510).

The data link layer (600B) performs functions such as link-level error detection, status tracking, power management status transmission, and initializations of flow control. Similar to transaction layer (600A), the data link layer (600B) adds a sequence number (604) and a link CRC (LCRC) (612) to the packet generated by the transaction layer (600A), adding 1 DW and 2 bytes in the process.

The physical layer (600A) performs functions such as link training/status, packet framing, data scrambling, symbol locking, as well as various electrical functions. In the illustrated example, one start byte (602) and one end byte (614) are added to delineate the packet.

The specific details of the transaction layer (600A), data link layer (600B), and physical layer (600C) are not expounded upon in detail and reference may be made to the PCIe standards for specific details of these layers.

Each layer (508A-508D) adds additional processing time for each packet, specifically, for unwrapping the layers payload and performing various functions handled by the layer. Table 1 illustrates the latency in supporting each layer as well as the time in “flight” (i.e., on wire):

| Layer | Delay (ns) | Percentage |
|---|---|---|
| Tx Transaction | 1056 | 71% |
| Tx Data Link | 336 | 22% |
| Tx Physical | 32 | 2% |
| Tx Transceiver | 72 | 5% |
| Tx Total | 1496 | 100% |
| Flight Time | ~1 | negligible |

As illustrated above in Table 1, 93% of transaction times when using each layer of the PCIe standard is devoted to transaction and data link processing. To improve the performance of message passing over PCIe, the disclosed embodiments bypass these layers and only utilize the physical layer (508D) and application layer (508A), as illustrated by datapath (518).

FIG. 6B is a packet diagram illustrating an improved PCIe packet according to one embodiment.

As illustrated, payload (608) is split into multiple sub-payloads (618A-618C). In one embodiment, the payload (608) is split into fixed-size packets for further processing. Each sub-payload (618A-618C) has a start byte (616A-616C) and end byte (620A-620C) attached to the beginning and end of the sub-payloads, respectively. The resulting packet thus comprises only two extra bytes of data per fixed chunk, since the transaction and data link layer header/trailers are removed from the packet.

In the illustrated packet, the error-checking facilities of the physical layer of the PCIe standard are used to quickly check the sanity of the packet. In contrast to standard PCIe packets, more robust error correction routines (e.g., LCRC and ECRC) that consume processing time/resources are avoided. Additionally, given the lightweight nature of the packet, packets with errors are simply retransmitted rather than corrected using such error correction routines.

Returning to FIG. 5, packets are processed according to the physical layer (508D) and application layer (508A), while bypassing the transaction and data link layers (508B-508C). In some embodiments, the SSD (506) may retain the transaction and data link layer (508B-508C) functionality to maintain backward compatibility for traditional PCIe packets.

After processing the packets using either all layers (508A-508D) or only the application layer (508A) and physical layer (508D), the processed data is transmitted to the SSD processors (510) and DRAMS (512) for processing. This processing is described previously and is not repeated herein for the sake of clarity.

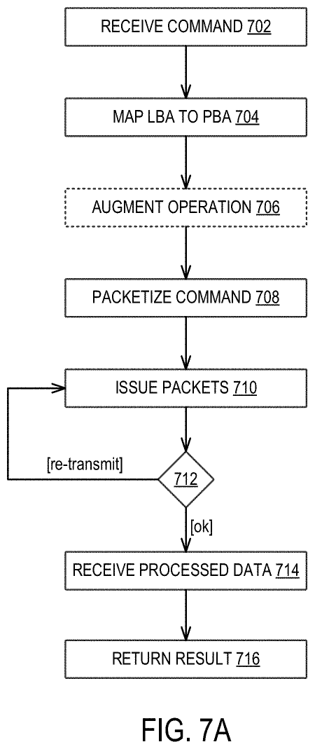

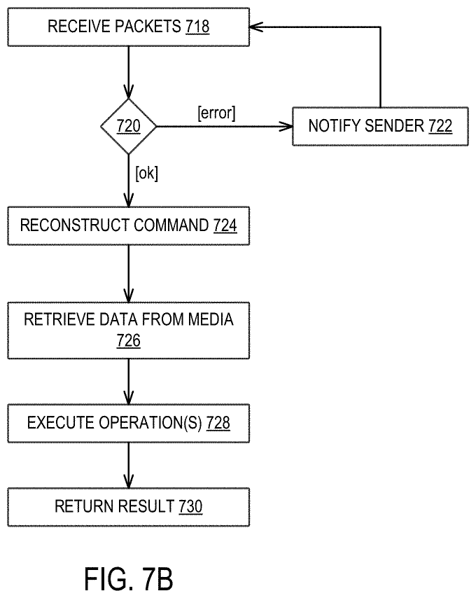

FIG. 7A is a flow diagram illustrating a method for performing global FTL mapping according to some embodiments of the disclosure.

In step 702, the method receives a command. In one embodiment, a command comprises any command that accesses data stored in, for example, a solid-state storage device or other type of storage device. Examples of commands comprise read, write, erase, modify, and other data access commands. In one embodiment, a command includes at least one LBA generated by a block device driver.

In step 704, the method maps LBAs in the command to PBAs. In the illustrated embodiment, the method utilizes a global FTL stored within system memory. In the illustrated embodiment, the method may be performed by a processing core of a multi-core processor (or, alternatively, by a processor comprising a single-core processor). The system memory comprises DRAM or similar storage mechanisms directly accessible by the processor or processor core. As described above, the system memory includes a mapping of LBAs to PBAs and in step 704, the method may replace the existing LBA in the command with a PBA using this mapping.

In optional step 706, the method augments the command with an operation. In one embodiment, augmenting a command comprises inserting a flag associated with an operation into the command. The flag may comprise a byte or two bytes that specify an integer flag representing an operation. As previously discussed, a receiving device may store a mapping of subroutines to flags generated in step 706. In alternative embodiments, augmenting a command comprises inserting executable code into the command. In one embodiment, executable code comprises instructions for processing data to be returned in response to the command. This executable code may be in the form of machine code, assembly code, byte code, or any other representation executable by a receiving device.

As illustrated, step 706 may be optional. That is, the method may proceed without augmenting a command with operations. In this scenario, the receiver device may either perform no additional operations or may perform operations automatically, as will be discussed in connection with FIG. 7B.

After step 706, the method generates an augmented command. As an example, the command received in step 702 may comprise READRANGE LBA1 LBA5 SORT ASC, where LBA1 is a starting address and LBA5 is an ending address. The fictional READRANGE command reads a contiguous set of addresses. The SORT command sorts the returned data by its integer representation in ascending order. In step 704, the method would generate a second command as READ PBA10, PBA15, PBA1, PBA7, PBA6 SORT ASC. Here, LBA1 through LBA5 are mapped to PBA addresses 10, 15, 1, 7, and 6, respectively. Additionally, since the PBAs are not consecutively ordered, the method may optimize the command to comprise a READ command to read each individual PBA. Finally, the method may convert the SORT ASC operation to 0x00010001, where the first four bits represent the pointer to the operation and the final four bits are used as a flagging mask (0x0001 corresponding to ascending). The final command may appear as READ PBA10, PBA15, PBA1, PBA7, PBA6 0x00010001.

In step 708, the method packetizes the command. As described in connection with FIG. 6B, the method splits the command into packets. In one embodiment, these packets may comprise fixed-size chunks of the original command. Continuing the previous example, the command “READ PBA10, PBA15, PBA1, PBA7, PBA6 0x00010001” may be split into seven packets one for the READ command, one for the 0x00010001 flag and five packets for the PBAs. In one embodiment, the method appends a PCIe physical layer start preamble and end trailer as illustrated in FIG. 6B to each packet. In one embodiment, the method may issue an additional STOP packet to indicate the end of a sequence of packets

In step 710, the method issues the packets to an SSD over, for example, a PCIe bus. In one embodiment, the packets are issued in order while in others the order is not required. In either embodiment, the receiving device (e.g., an SSD) may receive the packets out of order.

In step 712, the method determines if any packets must be re-transmitted. If so, the method retransmits the packets requiring retransmission in step 710. In one embodiment, the receiving device uses the PCIe physical layer preamble and trailer to quickly check the sanity of the packet and transmits an identifier of the packet to the method to trigger retransmission. In one embodiment, the method only retransmits single packets. In other embodiments, the method may retransmit all packets upon determining that a single packet in the packetized command has failed.

In step 714, after the method has successfully transmitted all packets, the method awaits a result and receives processed data from the receiver device. As described above, the processed data may comprise the data requested by the command (if no operation was specified or executed by the receiver) or may comprise a modified result generated based on an operation performed by the receiver device.

In step 716, the method returns the result received in step 714 as the return value of the command issued in step 702.

FIG. 7B is a flow diagram illustrating a method for performing in-storage computations according to some embodiments of the disclosure.

In step 718, the method receives packets over a bus. In one embodiment, the method illustrated in FIG. 7B is executed by a microprocessor of a storage device such as an SSD. In the illustrated embodiment, the packets received in step 718 correspond to the packets generated and issued in the method illustrated in FIG. 7A.

In step 720, the method analyzes a packet to determine if the packet passes a sanity check. As described above, the sanity check may be performed using the preamble or trailer of the packet generated using the physical layer start/end bytes. If the packet does not pass the sanity check, the method notifies the sender in step 722. In one embodiment, the method may transmit an identifier (e.g., frame number) of the packet that did not pass the sanity check back to the sending device. In one embodiment, the method may continue processing other packets incoming while awaiting retransmission of the packet or packets that did not pass the sanity check. In other embodiments, the method may cease processing all packets in the sequence and await retransmission of the packets corresponding to the entire command.

In step 724, the method reconstructs a command corresponding to the packet after all packets have passed the sanity check. In one embodiment, the method uses a frame number in the preamble or trailer of the packet to rearrange the packets in the correct order. In other embodiments, the method may utilize the structure of the data in the packet to re-order the packets. For example, command, PBA, and operation packets may be prefixed with distinct fields to distinguish between the packets. For example, the method may rearrange the packets to identify the command first, separate the PBAs, and then separate the operation/arguments to the operation.

In step 726, the method retrieves data from the storage media. In one embodiment, the storage media comprises a NAND Flash array. In the illustrated embodiment, the method may retrieve the data using the PBAs in the received packets and using a standard NAND interface. In one embodiment, the method transfers the returned data into memory for further processing.

In step 728, the method executes one or more operations on the data stored in memory in step 726.

In one embodiment, the method selects the operations using a flag of an operation included in the command. In this embodiment, the method stores operations in memory as well as a table mapping flags to starting addresses of the operations in memory. Upon detecting the return of all data from the media into memory, the method switches the execution of the processor to the address of the operation, supplies any arguments for the operation (e.g., sort order), and sets the data pointer of the operation to the location of the return data. The method then executes the operations using the returned data to generate a return value or result set.

In another embodiment, the method may receive the code of the operations to execute in the command itself. In this embodiment, the method may store the commands to execute at a designated location in memory. In one embodiment, the memory may be configured with one or more reserved pointers in the table described above. The reserved pointers may be pointed to a fixed-sized area in memory where the method writes the received operations. Upon detecting all data was returned in step 726, the method executes the code pointed to by the reserved pointer and continues as described above.

In step 728, the method returns the result of the operations to the requesting device. In some embodiments, the returned data may comprise the requested data transformed using a mapping function. In other embodiments, the returned data may comprise a single value generated using a reducer function. In general, the form of the returned data is not intended to be limited and may be in any form based on the underlying operations.

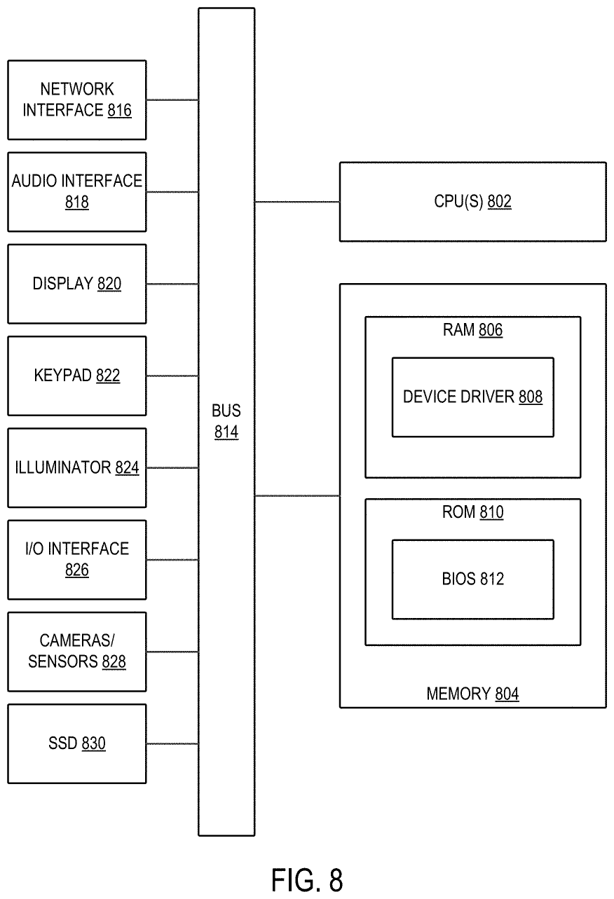

FIG. 8 is a hardware diagram illustrating a device for accessing an SSD according to some embodiments of the disclosure.

Client device may include many more or fewer components than those shown in FIG. 8. However, the components shown are sufficient to disclose an illustrative embodiment for implementing the present disclosure.

As shown in FIG. 8, client device includes processing units (CPUs) (802) in communication with a mass memory (804) via a bus (814). Client device also includes one or more network interfaces (816), an audio interface (818), a display (820), a keypad (822), an illuminator (824), an input/output interface (826), and a camera(s) or other optical, thermal or electromagnetic sensors (828). Client device can include one camera/sensor (828), or a plurality of cameras/sensors (828), as understood by those of skill in the art.

Client device may optionally communicate with a base station (not shown), or directly with another computing device. Network interface (816) includes circuitry for coupling client device to one or more networks and is constructed for use with one or more communication protocols and technologies. Network interface (816) is sometimes known as a transceiver, transceiving device, or network interface card (NIC).

Audio interface (818) is arranged to produce and receive audio signals such as the sound of a human voice. For example, audio interface (818) may be coupled to a speaker and microphone (not shown) to enable telecommunication with others and generate an audio acknowledgment for some action. Display (820) may be a liquid crystal display (LCD), gas plasma, light emitting diode (LED), or any other type of display used with a computing device. Display (820) may also include a touch sensitive screen arranged to receive input from an object such as a stylus or a digit from a human hand.

Keypad (822) may comprise any input device arranged to receive input from a user. For example, keypad (822) may include a push button numeric dial, or a keyboard. Keypad (822) may also include command buttons that are associated with selecting and sending images. Illuminator (824) may provide a status indication and provide light. Illuminator (824) may remain active for specific periods of time or in response to events. For example, when illuminator (824) is active, it may backlight the buttons on keypad (822) and stay on while the client device is powered. Also, illuminator (824) may backlight these buttons in various patterns when particular actions are performed, such as dialing another client device. Illuminator (824) may also cause light sources positioned within a transparent or translucent case of the client device to illuminate in response to actions.

Client device also comprises input/output interface (826) for communicating with external devices, such as UPS or switchboard devices, or other input or devices not shown in FIG. 8. Input/output interface (826) can utilize one or more communication technologies, such as USB, infrared, Bluetooth™, or the like.

Mass memory (804) includes a RAM (806), a ROM (810), and other storage means. Mass memory (804) illustrates another example of computer storage media for storage of information such as computer-readable instructions, data structures, program modules or other data. Mass memory (804) stores a basic input/output system (“BIOS”) (812) for controlling low-level operation of client device. The mass memory may also store an operating system for controlling the operation of client device. It will be appreciated that this component may include a general-purpose operating system such as a version of UNIX, or LINUX™, or a specialized client communication operating system such as Windows Client™, or the Symbian® operating system. The operating system may include, or interface with a Java virtual machine module that enables control of hardware components and operating system operations via Java application programs.

Memory (804) further includes a device driver (808). As discussed above, device driver (808) issues read, write, and other commands to storage devices (not illustrated). In one embodiment, the device driver (808) issues such commands to SSD (830). In one embodiment, SSD (830) may comprise a solid-state drive or similar device that implements one or more NAND Flash chips such as the chips described in the description of the preceding Figures which are incorporated by reference. In general, SSDs (830) comprise any NAND Flash-based device that implements local processing such as that illustrated in the preceding Figures.

For the purposes of this disclosure a module is a software, hardware, or firmware (or combinations thereof) system, process or functionality, or component thereof, that performs or facilitates the processes, features, and/or functions described herein (with or without human interaction or augmentation). A module can include sub-modules. Software components of a module may be stored on a computer readable medium for execution by a processor. Modules may be integral to one or more servers, or be loaded and executed by one or more servers. One or more modules may be grouped into an engine or an application.

Those skilled in the art will recognize that the methods and systems of the present disclosure may be implemented in many manners and as such are not to be limited by the foregoing exemplary embodiments and examples. In other words, functional elements being performed by single or multiple components, in various combinations of hardware and software or firmware, and individual functions, may be distributed among software applications at either the client level or server level or both. In this regard, any number of the features of the different embodiments described herein may be combined into single or multiple embodiments, and alternate embodiments having fewer than, or more than, all of the features described herein are possible.

Functionality may also be, in whole or in part, distributed among multiple components, in manners now known or to become known. Thus, myriad software/hardware/firmware combinations are possible in achieving the functions, features, interfaces and preferences described herein. Moreover, the scope of the present disclosure covers conventionally known manners for carrying out the described features and functions and interfaces, as well as those variations and modifications that may be made to the hardware or software or firmware components described herein as would be understood by those skilled in the art now and hereafter.

Furthermore, the embodiments of methods presented and described as flowcharts in this disclosure are provided by way of example in order to provide a more complete understanding of the technology. The disclosed methods are not limited to the operations and logical flow presented herein. Alternative embodiments are contemplated in which the order of the various operations is altered and in which sub-operations described as being part of a larger operation are performed independently.

While various embodiments have been described for purposes of this disclosure, such embodiments should not be deemed to limit the teaching of this disclosure to those embodiments. Various changes and modifications may be made to the elements and operations described above to obtain a result that remains within the scope of the systems and processes described in this disclosure.

What is claimed is:

1. A method comprising:
receiving, at a processor of a storage device, a command, the command including a physical block address (PBA);
retrieving, by the processor, data stored on a storage medium of the storage device using the PBA, the PBA representing the physical location of the data on the storage medium;
processing, using the processor and a memory of the storage device, the retrieved data to generate processed data; and
returning, by the processor to a host device coupled to the storage device, the processed data.

2. The method of claim 1, the receiving a command comprising receiving a flag identifying a program to run, the program stored within the memory of the storage device.

3. The method of claim 2, the processing the data comprising loading the program identified in the command into memory and executing the program after the retrieving the data.

4. The method of claim 2, the receiving a command comprising receiving a plurality of programs to run and the processing the data comprising executing the program and the plurality of programs on the data in a predefined sequence, the output of the executing of the predefined sequence generating the processed data.

5. The method of claim 1, the method further comprising temporarily storing the data in the memory after the retrieving the data.

6. The method of claim 1, the receiving a command comprising receiving a series of packets, each packet comprising a start field, end field, and a payload.

7. The method of claim 1, the receiving a command comprising receiving at least one instruction to run after the retrieving the data.

8. A method comprising:
receiving, by a processor of a host device, a first command, the first command including a logical block address (LBA);
mapping, by the processor, the LBA to a physical block address (PBA) using a mapping of LBAs to PBAs stored in a system memory of the host device; and
issuing, by the processor, a second command to a storage device, the second command including an operation and the physical block address, the second command causing the storage device to retrieve data at the PBA and execute the operation using a processing device and memory of the storage device.

9. The method of claim 8, further comprising storing an LBA-PBA mapping in the system memory, the LBA-PBA mapping representing LBA-PBA mappings for a plurality of storage devices coupled to the host device.

10. The method of claim 8, further comprising packetizing, by the processor, the first command prior to issuing the second command.

11. The method of claim 10, the packetizing comprising:
segmenting, by the processor, the first command into a series of payload packets;
adding, by the processor, a preamble and trailer to each payload packet; and
using, by the processor, the payload packets with preambles and trailers as the second command.

12. The method of claim 11, the issuing the second command comprising:
issuing, by the processor, each of the payload packets to the storage device; and
re-issuing, by the processor, a subset of the payload packets upon receiving an indication that a packet in the subset of payload packets was not processed by the storage device.

13. The method of claim 8, the packetizing the first command prior to issuing the second command comprising packetizing the first command using an application layer and physical layer of a PCIe interface, the packetizing further comprising bypassing a transaction layer and data link layer of the PCIe interface.

14. A storage device comprising:
an interface;
an array of storage media;
a processor; and
a memory for tangibly storing thereon program logic for execution by the processor, the stored program logic comprising:
logic, executed by the processor, for receiving a first command via the interface, the first command including a physical block address (PBA),
logic, executed by the processor, for retrieving data located at the PBA, the PBA representing a location of the data in the array of storage media,
logic, executed by the processor, for processing the data to generate processed data, the processing performed using the processor and the memory, and
logic, executed by the processor, for returning, via the interface, the processed data to a host device coupled to the storage device.

15. The storage device of claim 14, the interface comprising a Peripheral Component Interconnect Express (PCIe) interface.

16. The storage device of claim 14, the array of storage media comprising a NAND Flash array connected to the processor via a NAND interface.

17. The storage device of claim 14, the memory comprising a dynamic random-access memory (DRAM).

18. The storage device of claim 14, the logic for receiving a first command comprising one of:
logic, executed by the processor, for receiving a flag identifying a program to run, the program stored within the memory; and
logic, executed by the processor, for receiving at least one instruction to run after the retrieving the data.

19. The storage device of claim 18, the logic for processing the data comprising logic, executed by the processor, for loading the program identified in the first command into the memory and logic, executed by the processor, for executing the program after the retrieving the data.

20. The storage device of claim 18, the logic for receiving a first command comprising logic, executed by the processor, for receiving a plurality of programs to run and the logic for processing the data comprising logic, executed by the processor, for executing the program and the plurality of programs on the data in a predefined sequence, the output of the executing of the predefined sequence generating the processed data.

21. The storage device of claim 14 the logic for receiving a first command comprising logic, executed by the processor, for receiving a series of packets, each packet comprising a start field, end field, and a payload.
